(19) United States
(12) Patent Application Publication
(10) Pub. No.: US 2018/0086887 A1
(43) Pub. Date: Mar. 29, 2018

(54) PROCESS FOR CROSSLINKING POLYPROPYLENE

(71) Applicant: Akzo Nobel Chemicals International B.V., Amhem (NL)

(72) Inventors: Waldo Joseph Elisabeth BEEK, Deventer (NL); Auke Gerardus TALMA, Bathmen (NL); Jan Martijn VAN DER SCHUUR, Hengelo (NL)

(21) Appl. No.: 15/567,108

(22) PCT Filed: Apr. 24, 2016
(86) PCT No.: PCT/EP2016/058824

§ 371 Date: Oct. 17, 2017

(30) Foreign Application Priority Data
Apr. 24, 2015 (EP) 15165048.8

(51) Int. Cl. C08J 3/24; C08F 8/36; H01B 3/44; H01B 13/14

(52) U.S. Cl. CPC C08J 3/247; C08F 8/36; C08J 2323/26; H01B 13/14; H01B 3/441

(57) ABSTRACT

Process for crosslinking polypropylene comprising the steps of (a) treating a mixture of (i) polypropylene, (ii) a maleimide-functionalized mono-azide and/or a citraconimide-functionalized mono-azide, and (iii) a radical scavenger selected from the group consisting of hydroquinone, hydroquinone derivatives, benzoquinone, benzoquinone derivatives, catechol, catechol derivatives, 2,2,6,6-tetramethylpiperidinooxy (TEMPO), TEMPO derivatives, and combinations thereof, at a temperature in the range 120-250° C. to form a functionalized polypropylene, and (b) reacting the functionalized polypropylene with a peroxide at a temperature in the range 150-350° C.

The present invention relates to crosslinked polypropylene, its preparation, use, and recycling.

Typical wire and cable applications comprise at least one conductor surrounded by one or more layers of polymeric materials.

In some power cables, including medium voltage (MV), high voltage (HV) and extra high voltage (EHV) cables, the conductor is surrounded by several layers including an inner semiconductive layer, an insulation layer and an outer semiconductive layer. The outer semiconductive layer of the power cable can be non-strippable (i.e. bonded and non-peelable) or strippable (i.e. non-bonded and peelable). The conductor can be surrounded by an inner semiconductive layer which generally comprises crosslinked ethylene-based copolymer filled with conductive carbon black. The insulation layer is generally made of low density polyethylene (LDPE) that is crosslinked to give it desirable long term properties. The outer semiconductive layer is again a crosslinked semiconductive ethylene-based copolymer layer and this is often reinforced by metal wiring or covered by a sheet (metallic screening material).

For these cable and wire applications, but also for pipe and tube applications, there is a desire for polymeric materials that are more flexible and better resistant to high temperatures than crosslinked LDPE.

In addition, there is a desire for polymeric materials that are recyclable. Crosslinked LDPE is not recyclable.

It is expected that crosslinked polypropylene would meet these objectives.

In addition, it is expected that crosslinked polypropylene will have improved impact properties compared to non-crosslinked polypropylene, thereby enabling new, impact sensitive applications for polypropylene, such as car bumpers.

Unfortunately, polypropylene is not so easy to crosslink.

LDPE is commonly cured with peroxides. Polypropylene, however, is known to degrade upon peroxide treatment due to chain scission.

Although there are ways to crosslink polypropylene, these methods find limited application. One such method involves grafting of alkoxysilane onto the polypropylene, followed by moisture crosslinking of the silane functionalities. The grafting is performed by a free-radical process, which leads to degradation of the polypropylene and, therefore, a reduction in molecular-weight.

Hence, this is a rather inefficient crosslinking process and leads to low gel contents.

The object of the present invention is therefore to provide a process that enables the efficient crosslinking of polypropylene. A further object is the provision of crosslinked polypropylene that can be recycled.

These objects are achieved by the process according to the present invention, which involves the introduction of maleimide and/or citraconimide groups on the polypropylene backbone in the presence of a radical scavenger. During this introduction, nitrogen is released. The second step of the process involves the reaction between said maleimide and/or citraconimide groups with a peroxide.

The process according to the present invention therefore relates to a process for crosslinking polypropylene comprising the steps of
a. treating a mixture of (i) polypropylene, (ii) a maleimide-functionalized mono-azide and/or a citraconimide-functionalized mono-azide, and (iii) a radical scavenger selected from the group consisting of hydroquinone, hydroquinone derivatives, benzoquinone, benzoquinone derivatives, catechol, catechol derivatives, 2,2,6,6-tetramethylpiperidinooxy (TEMPO), and TEMPO derivatives, at a temperature in the range 120-250° C. to form a functionalized polypropylene, and
b. reacting the functionalized polypropylene with a peroxide at a temperature in the range 150-350° C.

In this specification, the term “polypropylene” refers to polypropylene homopolymers and propylene randomly co-polymerized with a small amount (<6 wt %) of other olefins, such as ethylene, 1-butene, and/or 1-octene.

It is noted that WO 2015/067531 discloses a process for modifying a polymer, e.g. polypropylene, with a maleimide-functionalized mono-azide at 80-250° C., followed by a thermal treatment at 150-270° C. A peroxide is preferably not present in the process. It is disclosed that this treatment may lead to crosslinking in the case of ethylene propylene copolymer and to branching in the case of polypropylene.

Maleimide-functionalized monoazides that can be used in the process of the present invention preferably have the formula:

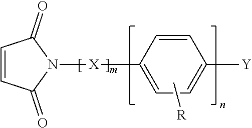

wherein Y is

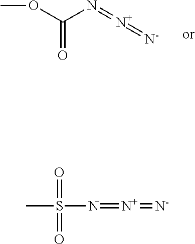

m is 0 or 1, n is 0 or 1, n+m=1 or 2, preferably 1, R is selected from the group consisting of hydrogen, linear and branched alkyl groups with 1-6 carbon atoms optionally substituted with O, S, P, Si, or N-containing functional groups, alkoxy groups with 1-6 carbon atoms, and halogens, and X is a linear or branched, aliphatic or aromatic hydrocarbon moiety with 1-12 carbon atoms, optionally containing heteroatoms.

Citraconimide-functionalized monoazides that can be used in the process of the present invention preferably have the formula:

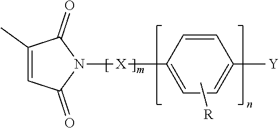

wherein Y is either

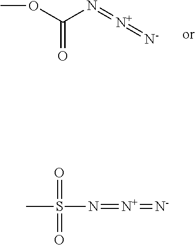

m is 0 or 1, n is 0 or 1, n+m=1 or 2, but preferably 1,

R is selected from the group consisting of hydrogen, linear and branched alkyl groups with 1-6 carbon atoms optionally substituted with O, S, P, Si, or N-containing functional groups, alkoxy groups with 1-6 carbon atoms, and halogens, and X is a linear or branched, aliphatic or aromatic hydrocarbon moiety with 1-12 carbon atoms, optionally containing heteroatoms.

In the above formulae, R is preferably hydrogen.

When X in the above formulae contains heteroatoms, it preferably has one of the following structures:

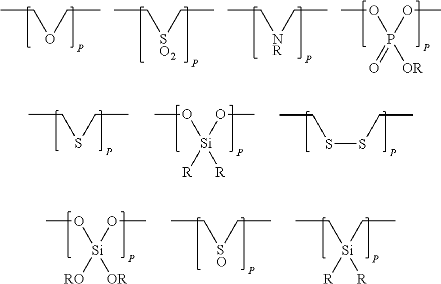

wherein P is an integer ranging from 1 to 6 and R is selected from the group consisting of H, alkyl, aryl, phenyl, and substituted phenyl groups.

More preferably, however, X is an aliphatic alkanediyl group with 1-12, more preferably 1-6, and most preferably 2-4 carbon atoms.

A particularly preferred maleimide-functional monoazide is 4-(2,5-dioxo-2,5-dihydro-1H-pyrrol-1-yl)benzenesulfonyl azide:

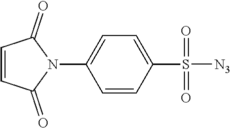 [SMILES: [N-]=[N+]=NS(=O)(=O)c1ccc(N2C(=O)C=CC2=O)cc1]

Particularly preferred citraconimide-functional monoazides are

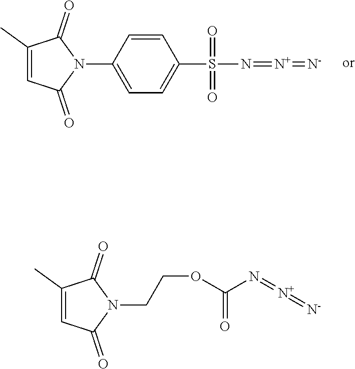 [SMILES: CC1=CC(=O)N(c2ccc(S(=O)(=O)N=[N+]=[N-])cc2)C1=O ; "or" ; CC1=CC(=O)N(CCOC(=O)N=[N+]=[N-])C1=O]

i.e. 4-(3-methyl-2,5-dioxo-2,5-dihydro-1H-pyrrol-1-yl)benzenesulfonyl azide (also called citraconimide benzenesulfonylazide) and 2-(3-methyl-2,5-dioxo-2,5-dihydro-1H-pyrrol-1-yl)ethyl carbonazidate (also called citraconimide-C2-azidoformate), respectively.

Maleimide-functional monoazides are preferred over citraconimide-functional monoazides in the process of the present invention.

During the functionalization step, the azide decomposes into nitrene radicals. Nitrene radicals are not only able to graft onto the polymer backbone—which is the object of the functionalization step—but can also abstract a hydrogen radical from the polymer backbone and initiate crosslinking of the maleimide/citraconimide groups. The latter effects are undesired as they lead to premature crosslinking and low grafting levels of maleimide/citraconimide functionalities on the polypropylene. Premature crosslinking leads to processing problems, inhomogeneities, and poor material properties.

Premature crosslinking is what happened in Example 2 of WO 2015/067531, wherein polypropylene homopolymer was treated with maleimide-sulfonylazide in the presence of Iroganox® 1010 at a temperature of 170° C., followed by a treatment at 200° C. In order to mitigate these undesired effects, a radical scavenger needs to be present during the functionalization step.

The radical scavenger is selected from hydroquinone, hydroquinone derivatives, benzoquinone, benzoquinone derivatives, catechol, catechol derivatives, 2,2,6,6-tetramethylpiperidinooxy (TEMPO), TEMPO derivatives, and combinations thereof. Examples of hydroquinone derivatives are t-butyl hydroquinone (TBHQ), 2,5-ditertiary-butylhydroquinone (DTBHQ), 2-methylhydroquinone (Toluhydroquinone, THQ), and 4-methoxyphenol.

An example of a benzoquinone is p-benzoquinone.

An example of a catechol derivative is 4-tert-butylcatechol.

Examples of TEMPO derivatives are 4-hydroxy-2,2,6,6-tetramethylpiperidin-1-oxyl (OH-TEMPO), 4-methoxy-2,2,6,6-tetramethylpiperidin-1-oxyl (4-methoxy-TEMPO), 4-carboxy-2,2,6,6-tetramethylpiperidin-1-oxyl (4-carboxy-TEMPO), and 4-oxo-2,2,6,6-tetramethylpiperidin-1-oxyl (TEMPONE).

The most preferred radical scavengers are TBHQ, TEMPO, OH-TEMPO, and combinations thereof.

In addition to said radical scavenger, additional anti-oxidants or radical scavengers may be present during the functionalization step. Examples of such additional anti-oxidants or radical scavengers are sterically hindered polynuclear phenols (e.g. Vulkanox® SKF, Vulkanox® DS, Vulkanox® BKF, Irganox® 1010), aminic antioxidants (e.g. Flectol® TMQ), diphenyl diamin based antioxidants (e.g. Santonox®6PPD), and phosphites (e.g. Weston TNPP).

Functionalization step a) can be performed in any suitable equipment capable of mixing polypropylene at a temperature in the range 80-250° C. Examples of such equipment are internal batch mixers (often called Banbury mixers), two-roll-mills (provided the rolls can be heated), extruders, and the like. The result of the functionalization is polypropylene containing maleimide and/or citraconimide functionalities.

The functionalized azide is preferably mixed with the polypropylene in an amount of 0.01-20 phr, more preferably 0.05-10 phr, and most preferably 0.1-5 phr. The term “phr” means: weight parts per hundred weight parts of polymer.

The radical scavenger is preferably mixed with the polypropylene in an amount of 0.02-2 phr, more preferably 0.05-1 phr, and most preferably 0.1-0.5 phr.

The functionalization is performed at a temperature in the range 120-250° C., preferably 140-230° C., more preferably 150-210° C., and most preferably 160-200° C. The temperature of choice depends on the type of azide.

Sulfonyl azides (azidosulfonates) typically start to decompose into reactive nitrene moieties around 130° C., with a peak around 180° C.; azidoformates start to decompose above 110° C., with a peak at 160° C. The formed nitrene moieties react with the polymer, resulting in grafting of the nitrene onto the polypropylene.

The preferred reaction time is 0.5-120 minutes, more preferably 1-60 minutes, and most preferably 2-30 minutes.

After the functionalization step, the functionalized polymer is reacted with a peroxide.

Examples of suitable peroxides are t-butyl cumyl peroxide, 3,6,9-triethyl-3,6,9,-trimethyl-1,4,7-triperoxonane, dicumyl peroxide, di(t-butylperoxyisopropyl) benzene, 2,5-dimethyl-2,5-di(tert-butylperoxy)hexane, 2,5-dimethyl-2,5-di(tert-butylperoxy) hexyne-3, and 3,3,5,7,7-pentamethyl-1,2,4-trioxepane.

The peroxide is preferably added to the functionalized polypropylene in an amount of 0.05-10 phr, more preferably 0.1-5 phr, and most preferably 0.25-2 phr.

The resulting mixture can be shaped in a desired form. This shaping can be performed in a mould (compression, injection or transfer moulding), an extruder (where shaping dies can be installed at the extruder head), or a calender (to process a polymer melt into a sheet or thin film). A so-called thermoforming process can be used to form shapes from foils or sheets of polypropylene. Power cables are commonly produced by extruding the layers on a conductor.

The shaped mixture is thermally treated at a temperature in the range 150-350° C., preferably 170-300° C., and most preferably 180-250° C. in order to allow the crosslinking reaction to occur.

Polypropylene crosslinked according to the process of the present invention can be recycled by treatment with a peroxide at a temperature in the range 150-350° C., preferably 180-300° C., most preferably 200-250° C.

Suitable peroxides are the ones listed above as suitable for the crosslinking step. Such treatment results in degradation of at least part of the crosslinks, which makes the resulting material suitable for re-use in non-crosslinked polypropylene applications by mixing it with virgin polypropylene or propylene copolymers. Examples of such applications are fibres (clothing or industrial), containers (e.g. food packages or compost bins), houseware (dishware, flower pots, gardening equipment), and automotive applications (e.g. dashboards).

### EXAMPLES

### Example 1

Polypropylene (50 g; Ineos 100GA12) was mixed with a maleimide sulfonyl azide (4-(2,5-dioxo-2,5-dihydro-1H-pyrrol-1-yl)benzenesulfonyl azide), optionally TBHQ, and optionally Irganox® 1010 (tetrakis-(methylene-(3,5-di-(tert)-butyl-4-hydrocinnamate))methane) in a pre-heated 50 ml Banbury internal mixer. Mixing was conducted at a temperature ranging from 180 to 190° C., a rotor speed of 50 rpm, for 10-12 minutes.

The torque in the Banbury mixer was recorded as a function of time. Premature crosslinking leads to an increase in torque, which means that the torque increase should as low as possible.

Table 1 reports the torque increase, relative to the torque of the starting polymer. It shows that, in the absence of TBHQ (Experiment 1A), significant premature crosslinking occurred. This premature crosslinking was reduced by the additional presence of TBHQ (experiments 1C-1F). The (additional) presence of Irganox® 1010 did not reduce premature crosslinking.

TABLE 1

| | | 1A | 1B | 1C | 1D | 1E | 1F |
|---|---|---|---|---|---|---|---|
| PP Ineos 100GA12 | phr | 100 | 100 | 100 | 100 | 100 | 100 |
| Irganox 1010 | phr | 0 | 1 | 0 | 0.5 | 1 | 2 |
| Maleimide | phr | 2 | 2 | 2 | 2 | 2 | 2 |
| sulfonylazide | | | | | | | |
| TBHQ | phr | 0 | 0 | 0.2 | 0.2 | 0.2 | 0.2 |
| Mixer torque | Nm | 10.6 | 10.5 | 4.6 | 5.5 | 4.9 | 4.9 |
| increase | | | | | | | |

### Example 2

The functionalized polypropylenes of Example 1 (experiments 1A-1F) were cooled to room temperature by ambient exposure and ground to ≦3 mm sized pieces on a granulator (Colortronic M102L), using a 3 mm screen.

T-butyl cumyl peroxide (Trigonox® T) was subsequently added to the granulated polypropylene and mixed for 4 hours in a tumbler mixer to allow proper homogenization.

All samples were cured for 30 minutes at 180° C. in a rheometer (MDR2000 ex Alpha Technologies).

The results are listed in Table 2, which indicates:

T5: time to 5% of maximal torque

T50: time to 50% of maximal torque

t90: time to 90% of maximal torque,

ML: minimum torque level,

MH: maximum torque level,

delta S=MH-ML.

ML is an indicator for the processability of the compound.

The functionalized polypropylenes of experiments 1A and 1B showed a significant torque increase in the mixer (see Example 1) and the highest ML values. Functionalization in the presence of TBHQ (experiment 2C) led to a significant reduction in the ML value, indicating an improved processability by reduced premature crosslinking.

The t90 data indicate that crosslinking was delayed by the presence of TBHQ (experiments 2C-2F).

In the absence of this radical scavenger (2A) or in the presence of Irganox 1010 (2B) not all maleimide groups are available for crosslinking the polypropylene and the effective result is degradation of the polypropylene initiated by the peroxide.

TABLE 2

| | | 2A | 2B | 2C | 2D | 2E | 2F |
|---|---|---|---|---|---|---|---|
| PP ex Example 1 | | 1A | 1B | 1C | 1D | 1E | IF |
| Trigonox ® T | phr | 0.7 | 0.7 | 0.7 | 0.7 | 0.7 | 0.7 |
| Rheometer cure | [° C.] | 180 | 180 | 180 | 180 | 180 | 180 |
| temperature | | | | | | | |
| t5 | [Min] | 0.8 | 0.7 | 0.9 | 1.0 | 0.9 | 0.9 |
| t50 | [Min] | 1.0 | 1.0 | 1.7 | 1.7 | 2.0 | 1.7 |
| t90 | [Min] | 1.3 | 1.4 | 3.8 | 3.6 | 4.6 | 3.4 |
| ML | [dNm] | 0.5 | 0.5 | 0.3 | 0.2 | 0.2 | 0.2 |
| MH | [dNm] | 0.8 | 1.0 | 0.9 | 1.0 | 1.0 | 1.1 |
| Delta S | [dNm] | 0.3 | 0.5 | 0.7 | 0.8 | 0.8 | 1.0 |

### Example 3

Polypropylene was functionalized and crosslinked in accordance with experiments 2C-2F by compression moulding into sheets of 1 mm thickness at a temperature of 180° C., for the time periods indicated in Table 3. The crosslinked polypropylene was subjected to refluxing xylene (140° C.) for 16 hours. The gel content of the crosslinked polypropylene is defined as the sample weight after extraction, relative to the sample weight prior to extraction.

Table 3 shows that polypropylene modified with 2 phr of the maleimidobenzene sulfonylazide in the presence of TBHQ can be crosslinked to a gel fraction above 80% using 0.7 phr of Trigonox® T.

Polypropylene functionalized according to experiment 1F, absent of peroxide treatment (exp. 3ref), dissolved completely in refluxing xylene. This indicates that functionalization with the maleimide sulfonylazide was not sufficient for obtaining crosslinks. A subsequent peroxide treatment was required for crosslinking to occur.

The hot set value is an indicator for the creep resistance at high temperature under a fixed load. This value was determined by subjecting test species (1 mm thick dumbbell shaped sheets) to a temperature of 200° C. and a load of 20 N/mm² for 15 minutes and recording the change in elongation. A low hot set value means a proper resistance to this load, indicating a high temperature resistance. Uncrosslinked polypropylene (exp. 3ref) failed this test as it was unable to withstand this temperature and load.

TABLE 3

| | | 3C | 3D | 3E | 3F | 3ref |
|---|---|---|---|---|---|---|
| PP ex Example 1 | | 1C | 1D | 1E | IF | IF |
| Trigonox ® T | phr | 0.7 | 0.7 | 0.7 | 0.7 | 0 |
| Curetime in mould | [min] | 10 | 10 | 10 | 8 | |
| Gel | [%] | 82 | 82 | 83 | 83 | 0 |
| Hotset (200° C.) | [%] | 72 | 73 | 59 | 84 | FAIL |

### Example 4

Experiment 1F was repeated, using another type of polypropylene and the radical scavengers and amounts listed in Table 4.

The torque increase was measured and the results are displayed in Table 4.

TABLE 4
modification of polypropylene

| | | 4A | 4B | 4C |
|---|---|---|---|---|
| PP Polychim MF7 | phr | 100 | 100 | 100 |
| Irganox 1010 | phr | 2 | 2 | 2 |
| Maleimide sulfonylazide | phr | 1 | 1 | 1 |
| TBHQ | phr | | 0.1 | |
| OH-TEMPO | phr | | | 0.08 |
| Mixer torque increase | Nm | 7.5 | 0 | 0.7 |

Irganox® 1010 had a positive effect on the color of the sample: it reduced the discoloration affected by the azide.

Example 4B shows that premature crosslinking can be completely halted by the addition of TBHQ. OH-TEMPO also showed a strong effect on premature crosslinking.

### Example 5

The functionalized polypropylenes of Example 4 (experiments 4A-4C) were cooled to room temperature by ambient exposure and ground to ≦3 mm sized pieces on a granulator (Colortronic M102L) using a 3 mm screen.

3,6,9-Triethyl-3,6,9,-trimethyl-1,4,7-triperoxonane (Trigonox® 301) was subsequently added to the granulated polypropylene and mixed for 4 hours in a tumbler mixer to allow proper homogenization.

The samples were cured as described in Example 2.

The gel content was determined according to the method described in Example 3 and the results are displayed in Table 5. The use of OH-TEMPO gave a slightly improved gel content when compared to the use of TBHQ.

TABLE 5

| PP ex Example 4 | | 4A | 4B | 4C |
|---|---|---|---|---|
| Trigonox 301 | phr | 0 | 1 | 1 |
| Gel | [%] | 0 | 76 | 83 |

### Example 6

Polypropylene was functionalized and crosslinked in accordance with Example 2C by compression moulding into sheets of 1 mm thickness at a temperature of 180° C., for 10 minutes. The crosslinked material was cut into strips and heated in an internal mixer for 3 minutes at 160° C. in the presence of 2 phr Trigonox® T and optionally 0.1 wt % OH-TEMPO. The gel content (determined according Example 3) of 82 for the crosslinked polypropylene was reduced to 49 (treatment with Trigonox® T only) and 35 (treatment with Trigonox® T and OH-TEMPO), indicating de-crosslinking.

1. Process for crosslinking polypropylene comprising the steps of
a. treating a mixture of (i) polypropylene, (ii) a maleimide-functionalized mono-azide and/or a citraconimide-functionalized mono-azide, and (iii) a radical scavenger selected from the group consisting of hydroquinone, hydroquinone derivatives, benzoquinone, benzoquinone derivatives, catechol, catechol derivatives, 2,2,6,6-tetramethylpiperidinooxy (TEMPO), TEMPO derivatives, and combinations thereof, at a temperature in the range 120-250° C. to form a functionalized polypropylene, and
b. reacting the functionalized polypropylene with a peroxide at a temperature in the range 150-350° C.

2. Process according to claim 1 wherein the radical scavenger is selected from the group consisting of quinone, t-butyl hydroquinone (TBHQ), 2,5-ditertiary-butylhydroquinone (DTBHQ), 2-methylhydroquinone (toluhydroquinone, THQ), p-benzoquinone, catechol, 4-methoxyphenol 4-tert-butylcatechol, 2,2,6,6-tetramethylpiperidinooxy (TEMPO), and 4-hydroxy-2,2,6,6-tetramethylpiperidin-1-oxyl (OH-TEMPO) 4-methoxy-2,2,6,6-tetramethylpiperidin-1-oxyl (4-methoxy-TEMPO), 4-carboxy-2,2,6,6-tetramethylpiperidin-1-oxyl (4-carboxy-TEMPO), 4-oxo-2,2,6,6-tetramethylpiperidin-1-oxyl (TEMPONE), and combinations thereof.

3. Process according to claim 2 wherein the radical scavenger is selected from the group consisting of t-butyl hydroquinone (TBHQ), 2,2,6,6-tetramethylpiperidinooxy (TEMPO), 4-hydroxy-2,2,6,6-tetramethylpiperidin-1-oxyl (OH-TEMPO), and combinations thereof.

4. Process according to claim 1 wherein the peroxide is selected from the group consisting of t-butyl cumyl peroxide, 3,6,9-triethyl-3,6,9,-trimethyl-1,4,7-triperoxonane, dicumyl peroxide, di(t-butylperoxyisopropyl) benzene, and 2,5-dimethyl-2,5-di(tert-butylperoxy)hexane.

5. Process according to claim 1 wherein a maleimide-functionalized mono-azide is used, said maleimide-functionalized azide having the following structure: 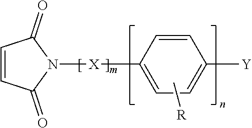
wherein Y is 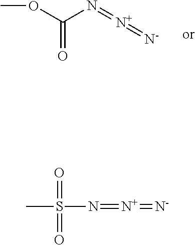
m is 0 or 1, n is 0 or 1, n+m=1 or 2, R is selected from the group consisting of hydrogen, linear and branched alkyl groups with 1-6 carbon atoms optionally substituted with O, S, P, Si, or N-containing functional groups, alkoxy groups with 1-6 carbon atoms, and halogens, and X is a linear or branched, aliphatic or aromatic hydrocarbon moiety with 1-12 carbon atoms, optionally containing heteroatoms.

6. Process according to claim 1 wherein a citraconimide-functionalized azide is used, said citraconimide-functionalized azide having the following structure: 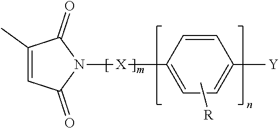
wherein Y is either 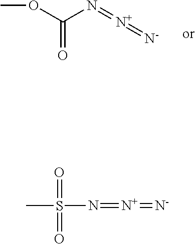
m is 0 or 1, n is 0 or 1, n+m=1 or 2, R is selected from the group consisting of hydrogen, linear and branched alkyl groups with 1-6 carbon atoms optionally substituted with O, S, P, Si, or N-containing functional groups, alkoxy groups with 1-6 carbon atoms, and halogens, and X is a linear or branched, aliphatic or aromatic hydrocarbon moiety with 1-12 carbon atoms, optionally containing heteroatoms.

7. Process for recycling crosslinked polypropylene, comprising the step of treating a crosslinked polypropylene obtainable by the process of claim 1 with a peroxide at a temperature in the range 150-350° C.

8. Process according to claim 7 wherein the peroxide is selected from the group consisting of t-butyl cumyl peroxide, 3,6,9-triethyl-3,6,9,-trimethyl-1,4,7-triperoxonane, dicumyl peroxide, di(t-butylperoxyisopropyl) benzene, and 2,5-dimethyl-2,5-di(tert-butylperoxy)hexane.

9. A power cable comprising the crosslinked polypropylene of claim 1 extruded onto a conductor.

10. A method of making an electrical cable comprising the step of shaping the crosslinked polypropylene of claim 1 with an extruder onto a conductor.

11. A method of making a tube comprising the step of shaping the crosslinked polypropylene of claim 1 with an extruder.
